(19) United States
(12) Patent Application Publication
(10) Pub. No.: US 2019/0221787 A1
(43) Pub. Date: Jul. 18, 2019

(54) CONNECTION MODULE COVER AND CONNECTION MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); TOYOTA JIDOSHA KABUSHIKI KAISHA, Aichi (JP)

(72) Inventors: Taiji YANAGIDA, Mie (JP); Shinichi TAKASE, Mie (JP); Yasuhiko KOTERA, Mie (JP); Yoshiaki KUROYANAGI, Mie (JP); Koichi TANAKA, Aichi (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); TOYOTA JIDOSHA KABUSHIKI KAISHA, Aichi (JP)

(21) Appl. No.: 16/248,194

(22) Filed: Jan. 15, 2019

(30) Foreign Application Priority Data
Jan. 16, 2018 (JP) 2018-004938

(51) Int. Cl. H01M 2/04; H01M 2/20; H01M 2/30; H01M 2/10

(52) U.S. Cl. CPC H01M 2/043; H01M 2/206; H01M 2220/20; H01M 2/1077; H01M 2/30

(57) ABSTRACT

A connection module cover is to be attached to a connection module that is to be assembled to a power storage element stack. The power storage element stack includes power storage element arrays. The power storage element array in a first array includes a first electrode terminal array. The power storage element array in a final array includes a second electrode terminal array. The connection module includes a first bus bar array for the first electrode terminal array, and a second bus bar array for the second electrode terminal array. The connection module cover includes a first cover part that covers the first bus bar array, and a second cover part that covers the second bus bar array. The first cover part includes an engaging part and a first coupling part. The second cover part includes an engaging part and a second coupling part.

### CROSS REFERENCE TO RELATED APPLICATION

This application claims priority from Japanese Patent Application No. 2018-004938 filed on Jan. 16, 2018. The entire contents of the priority application are incorporated herein by reference.

### TECHNICAL FIELD

The technology described herein relates to a connection module cover and a connection module including the cover, and specifically to an attachment structure for attaching a cover to a wiring module that is assembled to an upper part of a power storage element stack.

### BACKGROUND

In a power storage module for a vehicle such as an electric vehicle or a hybrid vehicle, power storage elements including electrode terminals of a positive electrode and a negative electrode is arranged. In this arrangement, the electrode terminals of the adjacent power storage elements are connected through a bus bar; thus, a power storage element array in which the power storage elements are connected in series is formed. In addition, generally, a bus bar module (connection module) that holds the bus bar is assembled to an upper part of the power storage element array. In the general bus bar module, a cover that insulates and protects a connection part between the bus bar and the electrode terminal is assembled to the bus bar module (for example, see Japanese Unexamined Patent Application Publication No. 2011-238544).

In general, a tolerance of an electrode pitch in a direction where the power storage elements are arranged in the power storage element array exists, and because of this tolerance, displacement occurs between the power storage element array and the bus bar module (stacking tolerance of power storage element array). In view of this, Japanese Unexamined Patent Application Publication No. 2011-238544 provides a movable part such as a hinge to the bus bar module and the cover of the bus bar module to deal with the tolerance of the electrode pitch.

In the power storage module, however, power storage element arrays, for example two power storage element arrays, may be provided because of the relation with the output voltage or the like. Therefore, a connection module cover that can deal with the tolerance of the electrode pitch of the power storage elements with a simple configuration has been desired for a power storage element stack including power storage element arrays.

### SUMMARY

The technology described herein was made in view of the above circumstances. An object is to provide, to a power storage element stack including power storage element arrays, a connection module cover that can deal with the tolerance of the electrode pitch of the power storage elements with a simple configuration.

A connection module cover to be disclosed in the present specification is a connection module cover that is to be attached to a connection module to be assembled to a power storage element stack. The power storage element stack includes power storage element arrays in each of which power storage elements including electrode terminals of a positive electrode and a negative electrode are arranged. The power storage element array in a first array includes a first electrode terminal array that is positioned at one end of the power storage element stack in a direction perpendicular to a direction where the power storage elements are arranged in the power storage element array. The power storage element array in a final array includes a second electrode terminal array that is positioned at another end of the power storage element stack in the direction perpendicular to the direction where the power storage elements are arranged. The connection module includes bus bars that electrically connect between the electrode terminals of the power storage element arrays. The bus bars include a first bus bar array for the first electrode terminal array and a second bus bar array for the second electrode terminal array. The connection module cover includes a first cover part that covers the first bus bar array, and a second cover part that covers the second bus bar array. The first cover part includes an engaging part that is engaged with one end of the connection module in the direction perpendicular to the direction where the power storage elements are arranged in a relatively movable manner, and a first coupling part that is directly or indirectly coupled to the second cover part in a relatively movable manner. The second cover part includes an engaging part that is engaged with another end of the connection module in the direction perpendicular to the direction where the power storage elements are arranged in a relatively movable manner, and a second coupling part that is directly or indirectly coupled to the first coupling part of the first cover part in a relatively movable manner.

In the present configuration, the connection module cover includes the first cover part for the first bus bar array and the second cover part for the second bus bar array, that are coupled directly or indirectly in a relatively movable manner. The first cover part is engaged with one end of the connection module (the first bus bar array) in a relatively movable manner, and the second cover part is engaged with the other end of the connection module (the second bus bar array) in a relatively movable manner. Therefore, even in the configuration where the first bus bar array and the second bus bar array of the connection module are moved in accordance with the tolerance of the electrode pitch of the power storage elements, the first cover part and the second cover part can move individually following the connection module that is moved. That is to say, by the connection module cover with the present configuration, the cover is split in accordance with the power storage element stack including the power storage element arrays, and the covers can be moved individually. With such a simple configuration, it is possible to deal with the tolerance of the electrode pitch of the power storage elements.

### BRIEF DESCRIPTION OF THE DRAWINGS

FIG. 1 is a perspective view of a power storage module including a connection module cover according to one embodiment.

FIG. 2 is an exploded perspective view of the power storage module.

FIG. 3 is a plan view of the power storage module.

FIG. 4 is a cross-sectional view taken along line B-B in FIG. 3.

FIG. 5 is a plan view of a connection module according to one embodiment.

FIG. 6 is a perspective view of a first cover part of the connection module cover.

FIG. 7 is a perspective view of a second cover part of the connection module cover.

FIG. 8 is a perspective view of a central cover part of the connection module cover.

FIG. 9 is a plan view of the connection module cover that is viewed from a back surface side.

FIG. 10 is a magnified view of a circular part indicated by an arrow A in FIG. 1.

FIG. 11 is a magnified view of a circular part indicated by an arrow D in FIG. 4.

FIG. 12 is a magnified view of a coupling part between the first cover part and the second cover part.

FIG. 13 is a magnified view of a circular part indicated by an arrow C in FIG. 3.

FIG. 14 is a magnified view of a circular part indicated by an arrow E in FIG. 4.

### DETAILED DESCRIPTION

### Embodiment

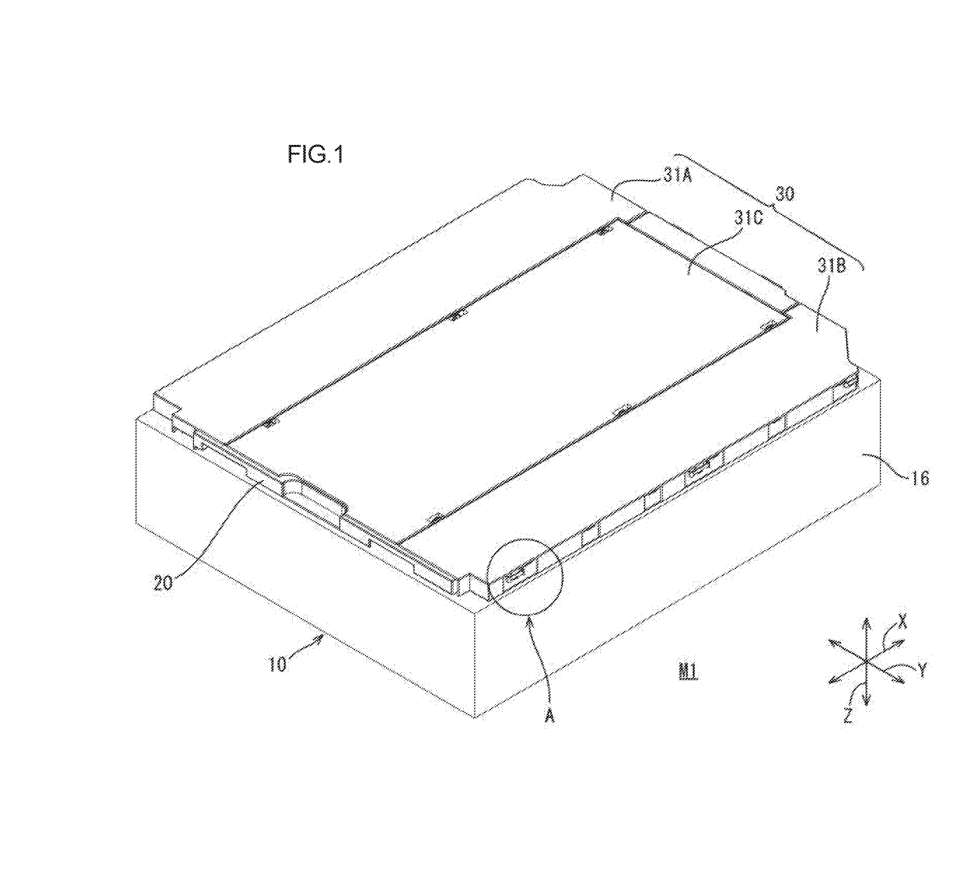

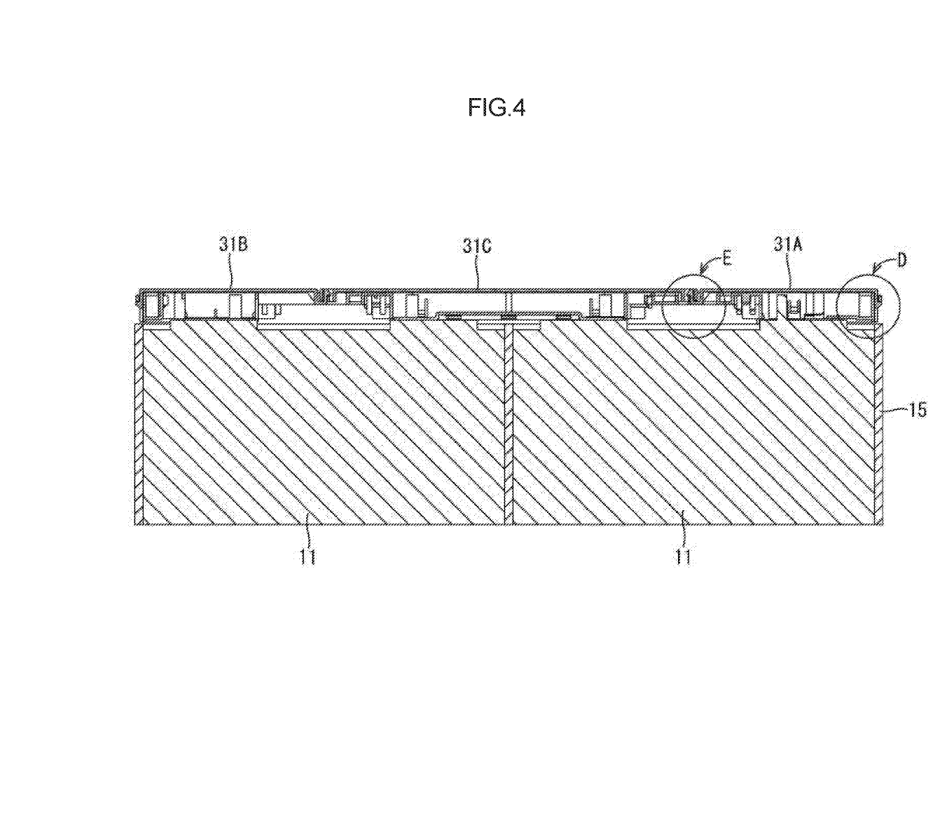

One embodiment is described with reference to FIG. 1 to FIG. 14. In the description below, the same members may be denoted by one reference sign, and the reference signs and description of the other members may be omitted.

### 1. Power Storage Module

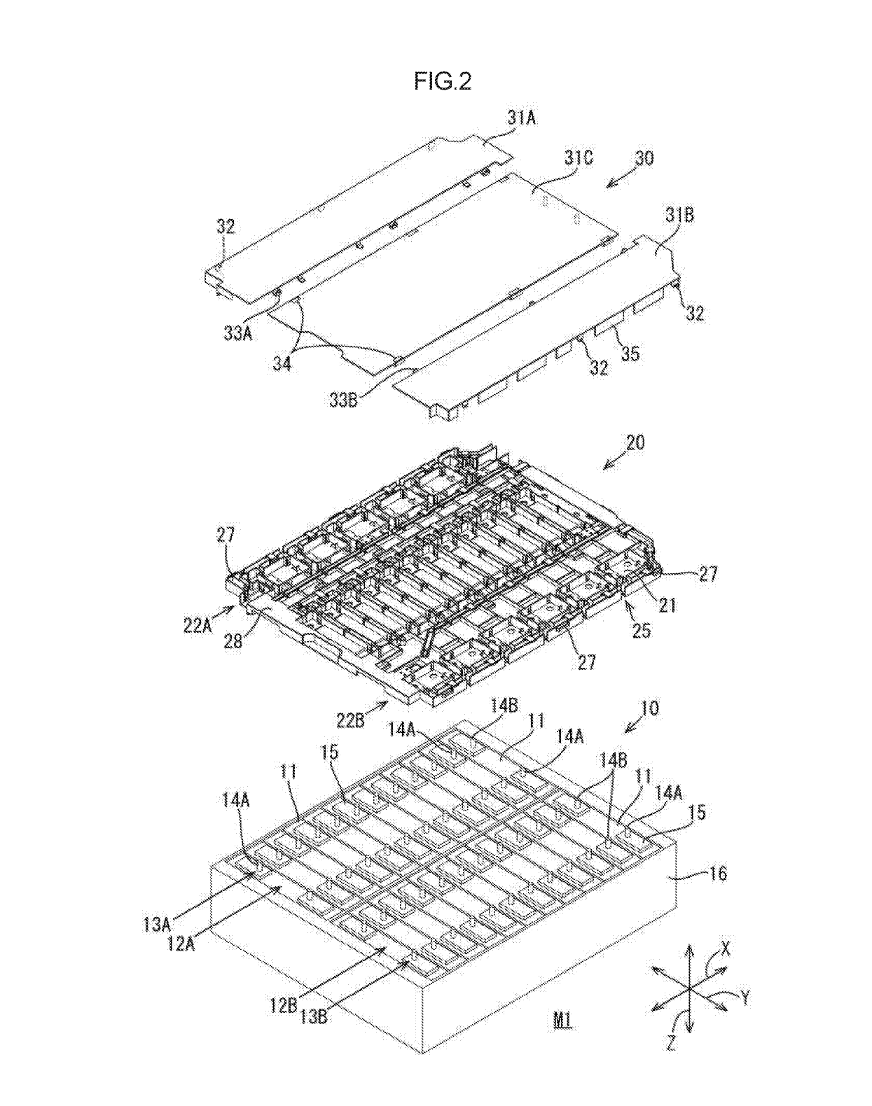

A power storage module M1 includes a power storage element stack 10, a connection module 20, and a connection module cover 30 as illustrated in FIG. 2. The power storage module M1 is used as, for example, a driving source of a vehicle such as an electric vehicle or a hybrid vehicle. In the power storage module M1 illustrated in FIG. 1, an arrow X indicates a direction (left-right direction) where power storage elements 11 are arranged, an arrow Y indicates a direction (front-back direction) perpendicular to the direction where the power storage elements 11 are arranged, and an arrow Z indicates an up-down direction.

### 2. Power Storage Element Stack

The power storage element stack 10 includes power storage element arrays 12 each including a plurality of (twelve in the present embodiment) power storage elements 11. In the present embodiment, the power storage element stack 10 includes two power storage element arrays (12A, 12B) as illustrated in FIG. 2. The two power storage element arrays are hereinafter simply referred to as the power storage element arrays 12 unless they need to be distinguished. The number of power storage element arrays 12 is not limited to two and may be, for example, three or four.

The first power storage element array (corresponding to the power storage element array in the first array) 12A includes a first electrode terminal array 13A positioned at one end (rear end) of the power storage element stack 10 in a direction (arrow-Y direction in FIG. 2) that is perpendicular to the direction (arrow-X direction in FIG. 2) where the power storage elements 11 are arranged. In addition, the second power storage element array (corresponding to the power storage element array in the final array) 12B includes a second electrode terminal array 13B positioned at the other end (front end) of the power storage element stack 10 in the direction that is perpendicular to the direction where the power storage elements 11 are arranged. Note that the first power storage element array 12A and the second power storage element array 12B are hereinafter simply referred to as the power storage element array 12 unless they need to be distinguished. Moreover, the first electrode terminal array 13A and the second electrode terminal array 13B are hereinafter referred to as the electrode terminal array 13 simply unless they need to be distinguished.

Each power storage element 11 includes a positive electrode terminal 14A and a negative electrode terminal 14B that project vertically from an upper surface of a main body part with a flat rectangular parallelepiped shape in which a power storage component that is not shown is housed. Note that the positive electrode and the negative electrode are hereinafter simply referred to as the electrode terminal 14 unless they need to be distinguished.

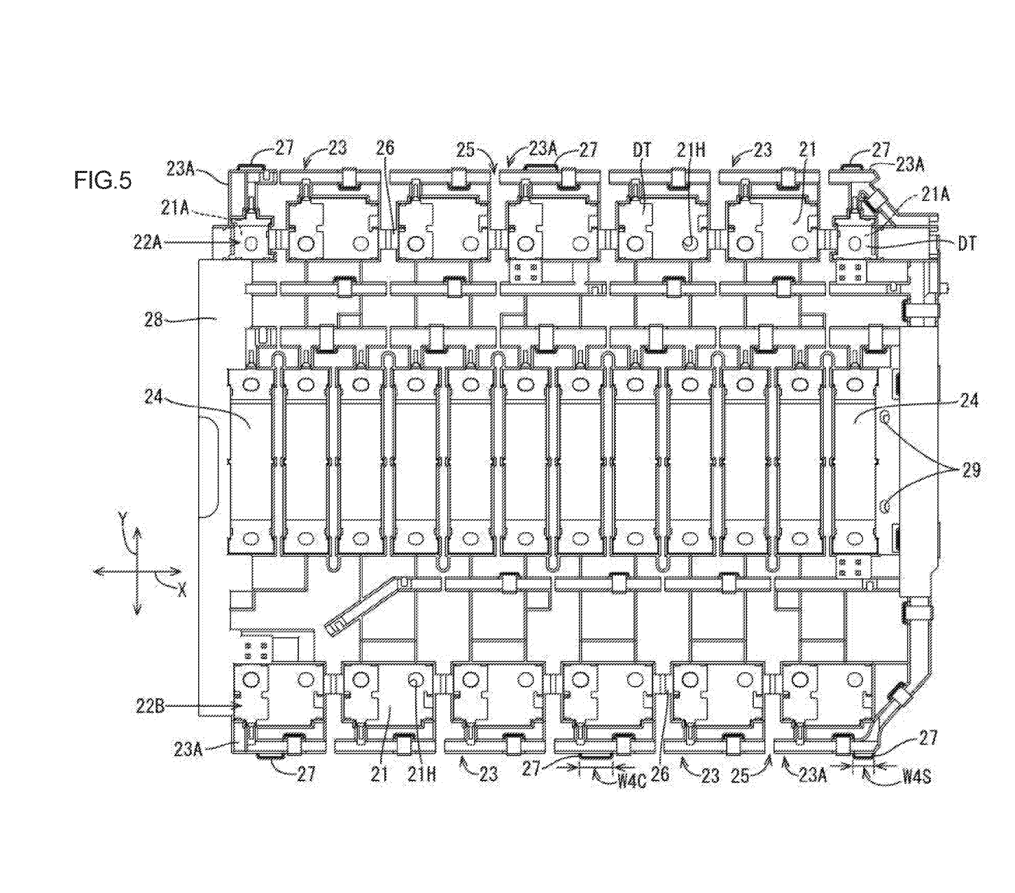

Each electrode terminal 14 is to be inserted into a terminal insertion hole 21H (see FIG. 5) of the bus bar 21. To a side wall part of the electrode terminal 14, a screw thread (not shown) to which a nut is fitted is formed.

When the bus bar 21 to which the electrode terminal 14 is inserted and a terminal board 15 are brought into contact with each other, the bus bar 21 and the electrode terminal 14 are electrically connected. In each power storage element array, the power storage elements 11 are disposed such that the electrode terminals 14 that are adjacent in the left-right direction (arrow-X direction) in FIG. 2 have opposite polarities. In regard to the first power storage element array 12A and the second power storage element array 12B, the power storage elements 11 are arranged such that the electrode terminals 14 that are adjacent in the front-back direction (arrow-Y direction) in FIG. 2 have opposite polarities.

In the power storage element stack 10, the first and second power storage element arrays (12A, 12B) are housed in a housing box 16.

### 3. Connection Module

The connection module 20 includes bus bars 21, bus bar holding parts 23, a communicating part 28, and the like as illustrated in FIG. 2 and FIG. 5.

Each bus bar 21 electrically connects between the electrode terminals 14 of the power storage element arrays 12. The bus bars 21 include a first bus bar array 22A for the first electrode terminal array 13A of the first power storage element array 12A, and a second bus bar array 22B for the second electrode terminal array 13B of the second power storage element array 12B.

Each bus bar 21 is formed of metal such as copper, copper alloy, stainless steel (SUS), or aluminum, and has a plate shape with the length in accordance with the distance between the adjacent electrode terminals 14 and 14 (electrode pitch). To each of the bus bars 21 other than the bus bar 21A at each upper end part in FIG. 5, a pair of terminal insertion holes 21H through which the electrode terminals 14 are inserted is formed to penetrate. Note that to the bus bar 21A at each upper end part in FIG. 5, only one terminal insertion hole 21H is formed to penetrate. The shape of the terminal insertion hole 21H is an oval shape that is long in the direction (arrow-X direction) where the power storage elements 11 are arranged.

In addition, bus bar holding parts 23A for the engaging parts 32 of a first cover part 31A to be described below include engaged parts 27 with which the engaging parts 32 are engaged in a manner that the relative movement is possible. The bus bar holding parts 23A for the engaging parts 32 of a second cover part 31B to be described below include the engaged parts 27 with which the engaging parts 32 are engaged in a manner that the relative movement is possible.

Thus, the first cover part 31A and the second cover part 31B can be engaged with the bus bar holding parts 23A in a manner that the relative movement is possible by the engaged parts 27. Therefore, in a configuration where the bus bar holding parts 23 move in accordance with the tolerance of the electrode pitch of the power storage elements 11, the connection module cover 30 can change in accordance with the tolerance of the electrode pitch.

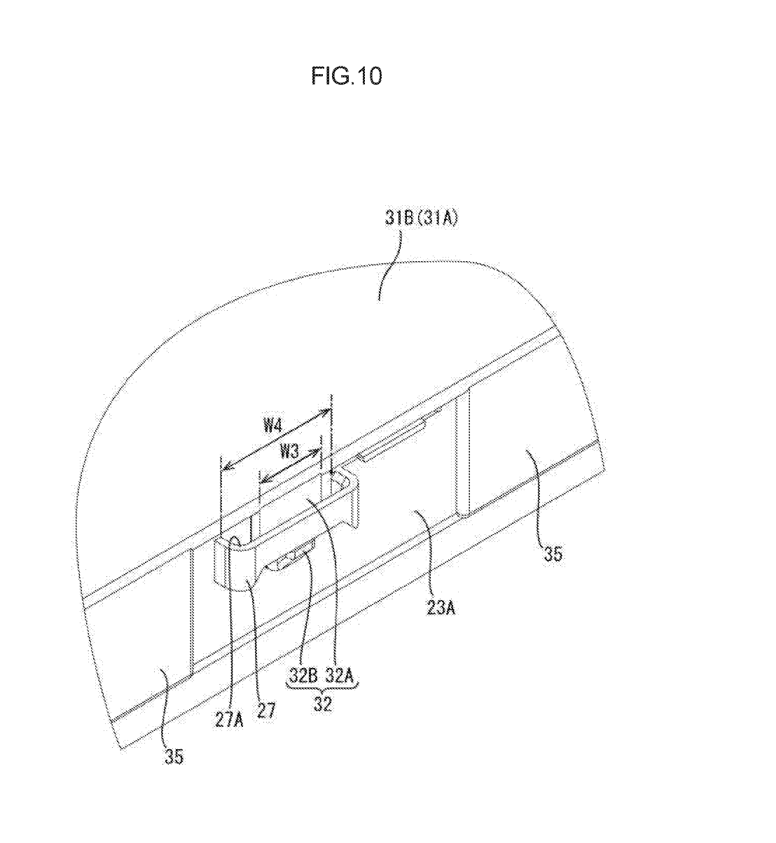

The engaged part 27 includes a curved wall 27 that projects from the bus bar holding part 23A as illustrated in FIG. 10. The engaging part 32 is engaged with this curved wall 27. The curved wall 27 includes an opening 27A into which the engaging part 32 is inserted and whose opening width W4 is larger than a plate width W3 of a plate part 32A of the engaging part 32.

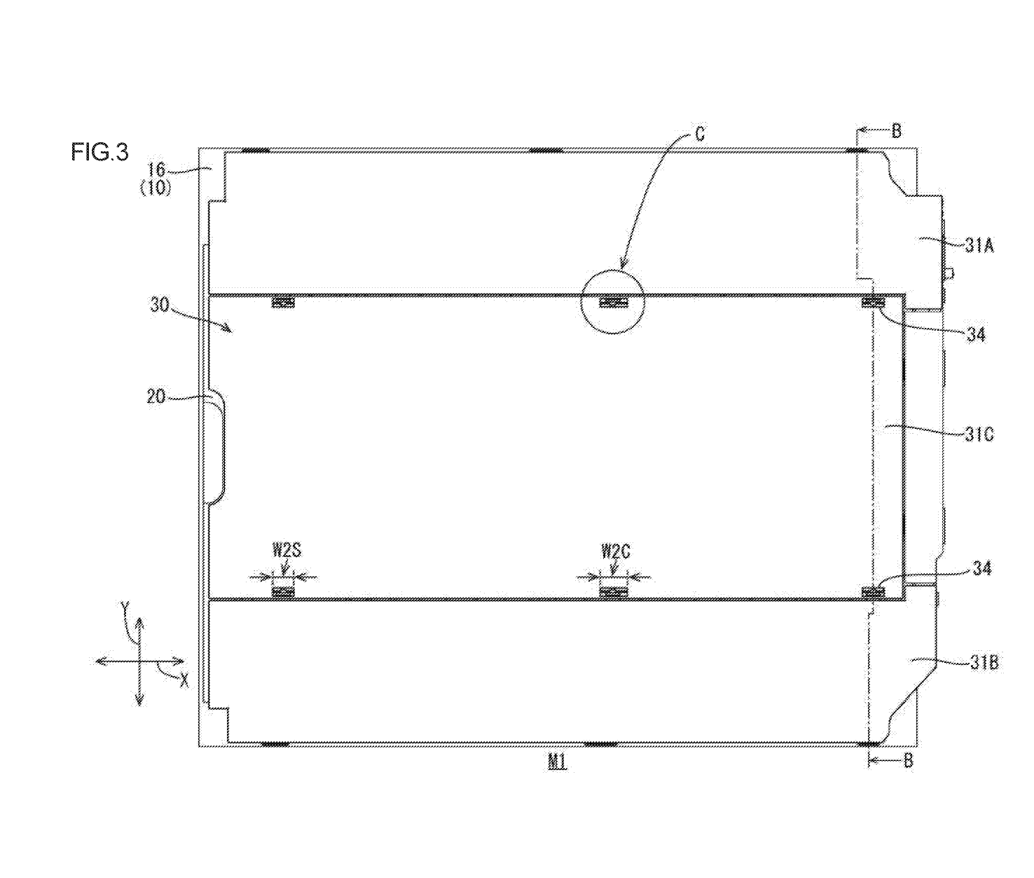

As illustrated in FIG. 5, curved walls (engaged parts) 27 is provided at a plurality of positions of the connection module 20 (in the present embodiment, at six positions: three at the front end and three at the rear end of the connection module 20) along the direction (arrow-X direction in FIG. 5) where the power storage elements 11 are arranged. An opening width W2 of the opening 27A of the curved wall 27 includes different opening widths. In the present embodiment, an opening width W4C of an opening 37A of the curved wall 27 provided at a central part in the arrow-X direction is larger than an opening width W4S of an opening 27A provided at each end in the arrow-X direction as illustrated in FIG. 3.

Thus, it is possible to deal with the tolerance of the electrode pitch of the power storage elements 11 more flexibly while the stability of attaching the cover 30 to the connection module 20 is secured, as compared to a case in which the opening width W4 of the opening 27A of each curved wall 27 is the same. That is to say, if the opening widths W4 of the openings 27A of all the curved walls 27 are large, the tolerance can be dealt with more flexibly; however, in this case, the stability of attaching the cover 30 becomes lower. Note that instead of this configuration, the opening widths W4 of the openings 27A of the curved walls 27 may be the same.

Between the bus bar holding parts 23, a slit 25 and a hinge 26 are provided to deal with the stacking tolerance of the power storage elements 11 in the power storage element array 12.

The connection module 20 includes, for example, an inter-array bus bar 24 connecting between the electrode terminals 14 of the first power storage element array 12A and the second power storage element array 12B, and the communicating part 28 that communicates between the first bus bar array 22A and the second bus bar array 22B. The communicating part 28 includes a pair of positioning grooves 29 to which positioning parts 36 of a central cover part 31C to be described below are fitted.

In addition, the connection module 20 includes a detection terminal DT that detects the voltage of the power storage element 11, a detection line (not shown) connected to the detection terminal DT, and the like. The detection terminal DT is connected to the bus bar 21 in the bus bar holding part 23, and the bus bar holding part 23 includes a routing part where the detection line is routed.

### 4. Connection Module Cover

The connection module cover 30 is a cover that is attached to the upper part of the connection module 20, and includes three split cover parts: the first cover part 31A, the second cover part 31B, and a central cover part 31C as illustrated in FIG. 2 and FIG. 3. In the present embodiment, the connection module cover 30 has a shape that covers the entire upper part of the connection module 20 as illustrated in FIG. 1 and FIG. 2. In this manner, since the connection module cover 30 has the configuration of covering the entire upper part of the connection module 20, a live part of the connection module 20 such as the bus bar 21 can be protected. The connection module cover 30 may be hereinafter referred to as the cover 30 simply.

The first cover part 31A covers the first bus bar array 22A of the connection module 20 and the second cover part 31B covers the second bus bar array 22B of the connection module 20. The central cover part 31C is disposed between the first cover part 31A and the second cover part 31B.

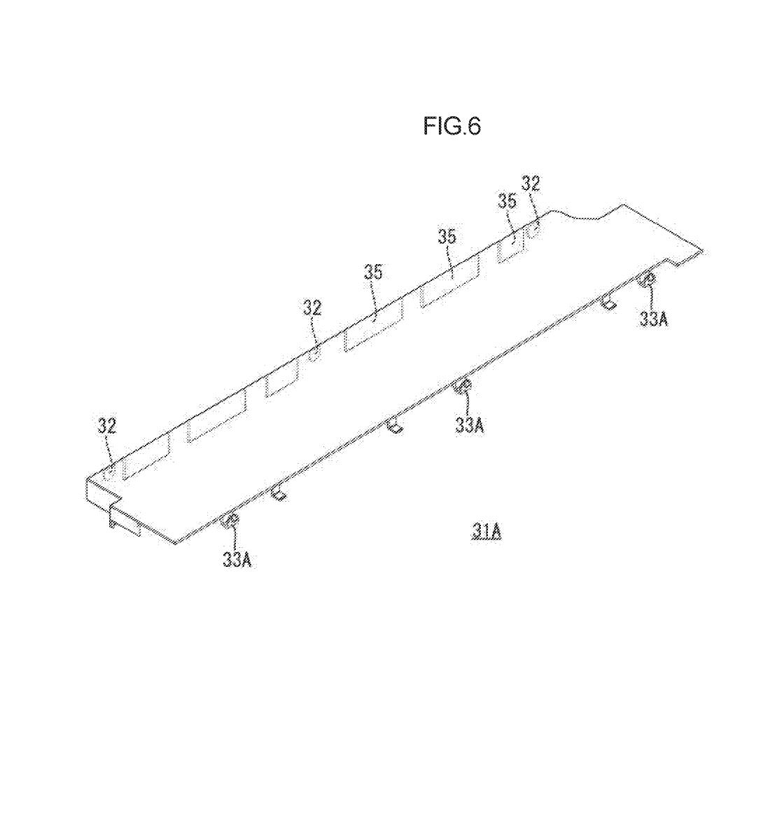

As illustrated in FIG. 6, the first cover part 31A includes the engaging parts 32 that are engaged with one end (rear end) of the connection module 20 in the direction (arrow-Y direction in FIG. 5) that is perpendicular to the direction where the power storage elements are arranged in a manner that the relative movement is possible, and first coupling parts 33A that are coupled to the second cover part 31B indirectly through the central cover part 31C in a manner that the relative movement is possible.

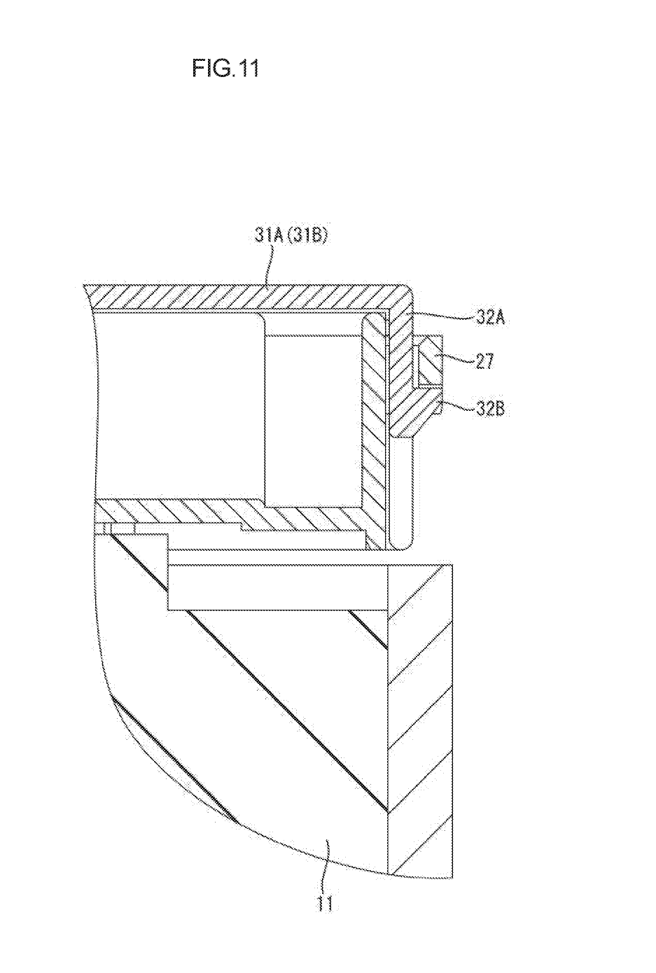

The engaging part 32 is engaged with the engaged part 27 of the bus bar holding part 23A in a manner that the relative movement is possible. In the present embodiment, the engaging part 32 includes the plate part 32A and a claw part 32B provided to the plate part 32A as illustrated in FIG. 10 and FIG. 11.

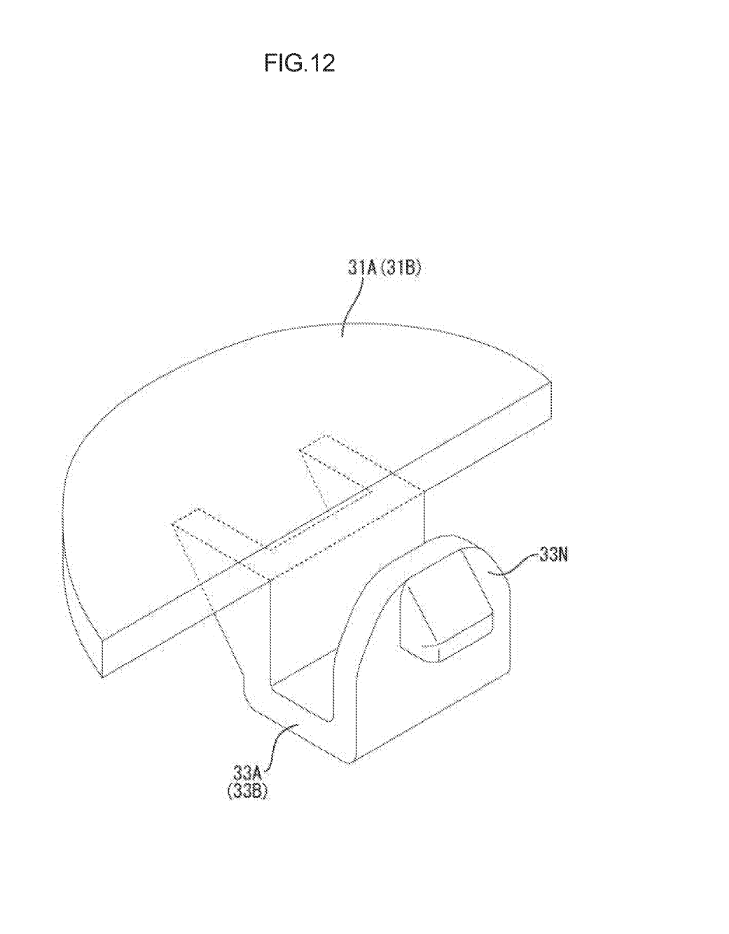

As illustrated in FIG. 12, the first coupling part 33A includes a fitting claw part 33N that is fitted by locking to a central coupling part 34 of the central cover part 31C to be described below.

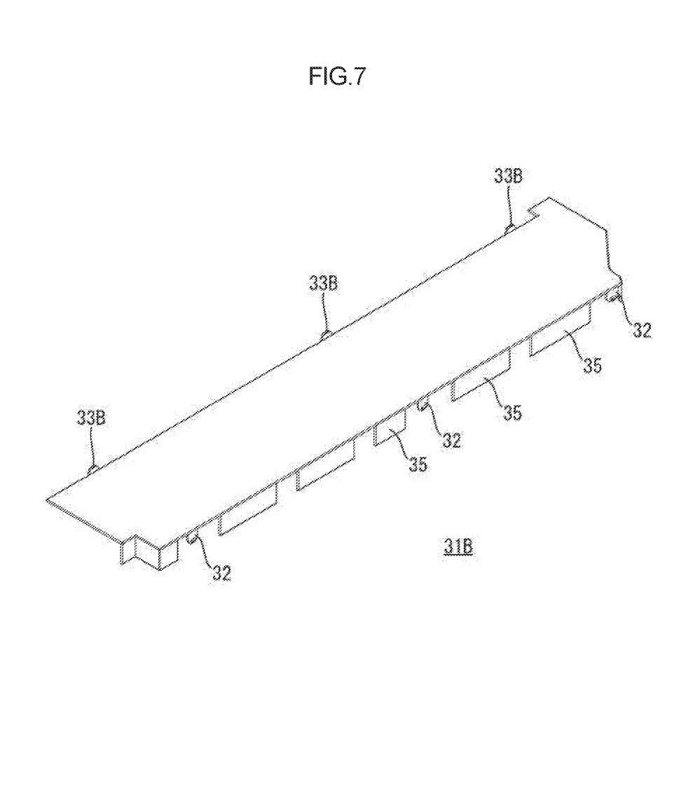

Similarly, as illustrated in FIG. 7, the second cover part 31B includes the engaging parts 32 that are engaged with the other end (front end) of the connection module 20 in the direction that is perpendicular to the direction where the power storage elements are arranged in a manner that the relative movement is possible, and second coupling parts 33B that are coupled to the first cover part 31A indirectly through the central cover part 31C in a manner that the relative movement is possible. In the present embodiment, the second coupling part 33B has the same shape as that of the first coupling part 33A (see FIG. 12). The first coupling parts 33A and the second coupling parts 33B are hereinafter referred to as the coupling parts 33 unless they need to be distinguished.

In addition, the first cover part 31A and the second cover part 31B include sidewalls 35 that cover the slits 25 of the connection module 20 as illustrated in FIG. 6 and FIG. 7. Since the sidewalls 35 of the first cover part 31A and the second cover part 31B close the slits 25 of the connection module 20, the live parts of the connection module 20 can be protected more certainly.

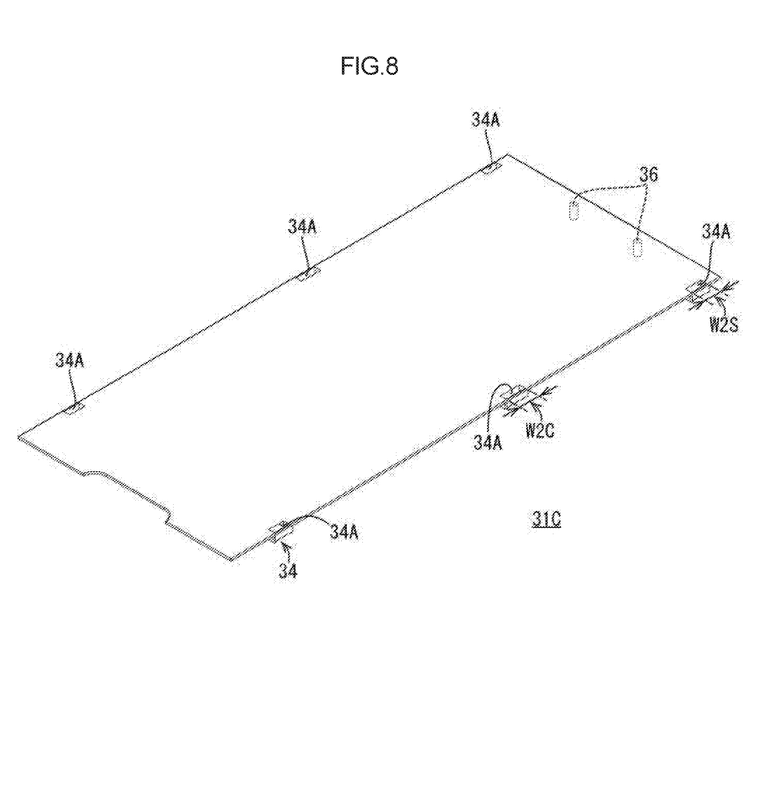

As illustrated in FIG. 8, the central cover part 31C includes the central coupling parts 34 that are coupled with the first coupling parts 33A and the second coupling parts 33B and coupled with the first cover part 31A and the second cover part 31B in a manner that the relative movement is possible.

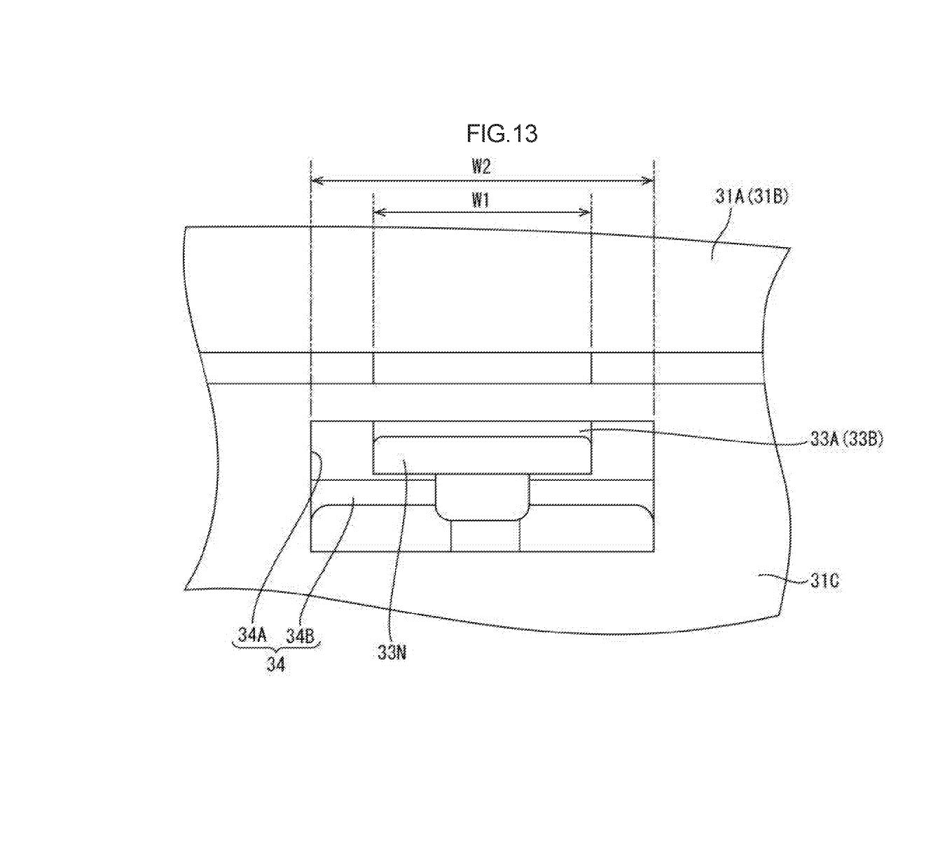

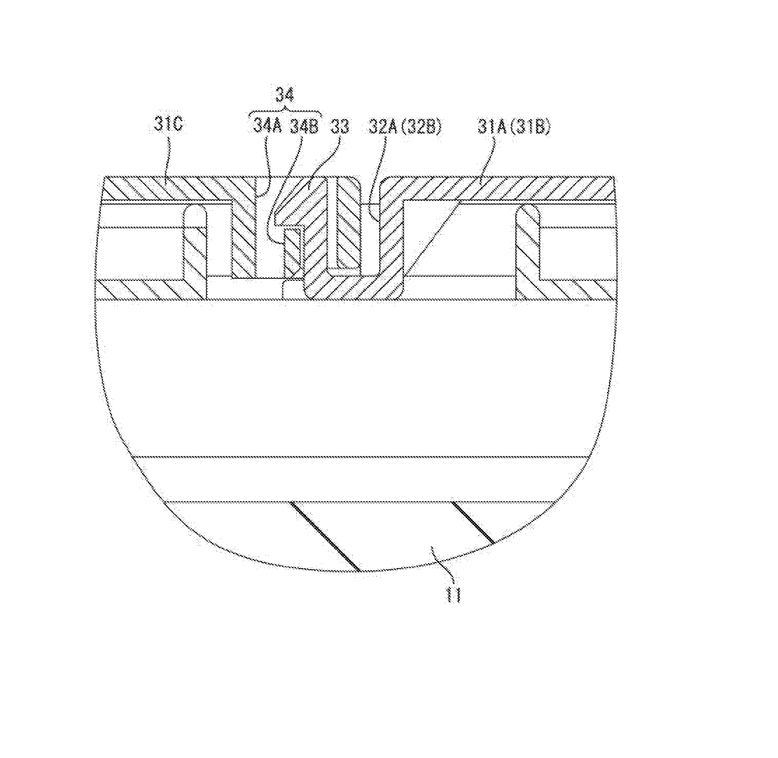

As illustrated in FIG. 13 and FIG. 14, the central coupling part 34 includes the opening 34A to which the fitting claw part 33N of the coupling part 33 is fitted and whose opening width W2 is larger than the claw width W1 of the fitting claw part 33N, and the locking part 34B that is formed in the opening 34A to lock the fitting claw part 33N.

In addition, as illustrated in FIG. 3 and FIG. 8, the central coupling parts 34 are provided at a plurality of positions (in the present embodiment, six positions including three at the front end and three at the rear end) on the central cover part 31C along the direction (arrow-X direction in FIG. 3) where the power storage elements 11 are arranged. The opening width W2 of the opening 34A of the central coupling part 34 includes different opening widths. In the present embodiment, an opening width W2C of the opening 34A of the central coupling part 34 provided at the central part in the arrow-X direction in FIG. 3 is larger than an opening width W2S of the opening 34A of the central coupling part 34 provided at each end in the arrow-X direction.

Therefore, in a manner similar to the case of the opening 27A of the curved wall 27, it is possible to deal with the tolerance of the electrode pitch of the power storage elements 11 more flexibly while the stability of attaching the cover 30 to the connection module 20 is secured, as compared to a case in which the opening width W2 of the opening 34A of each central coupling part 34 is the same. That is to say, if the opening widths of the openings 34A of all the central coupling parts 34 are large, the tolerance can be dealt with more flexibly; however, in this case, the stability of attaching the cover 30 deteriorates. Note that instead of this configuration, the opening widths W2 of the openings 34A of the central coupling parts 34 may be the same.

In addition, the central cover part 31C includes the positioning parts 36 configured to position the direction (arrow-X direction) where the power storage elements 11 are arranged with respect to the connection module 20. The positioning part 36 includes a pair of projections 36 with a stick-like shape in the present embodiment. When the cover 30 is attached to the connection module 20, the projection 36 with the stick-like shape is inserted into a positioning groove 29 of the connection module 20.

In this manner, since the central cover part 31C includes the positioning parts 36, the central cover part 31C can be fixed to the connection module 20 when the cover 30 is attached to the connection module 20. Thus, the work of attaching the cover 30 can be made more efficient. The first cover part 31A and the second cover part 31B are not fixed to the connection module 20; however, the central cover part 31C is fixed to the connection module 20 by the positioning parts 36. Thus, the attached state of the cover 30 is stabilized. Note that the positioning parts 36 may be omitted.

### 5. Method of Attaching the Connection Module Cover to the Connection Module

Next, description is made of a method of attaching the connection module cover 30 to the connection module 20. This method is one example, and other methods may be employed.

First, as illustrated in FIG. 2, the power storage element stack 10 in which the first power storage element array 12A and the second power storage element array 12B are housed in the housing box 16 is prepared.

Next, the connection module 20 is assembled to the surface of the power storage element stack 10 where the electrode terminal 14 of each power storage element 11 is formed. In this assembling, each electrode terminal 14 of the power storage element stack 10 is inserted into the terminal insertion hole 21H of the bus bar 21 and then, a nut is attached to each electrode terminal 14.

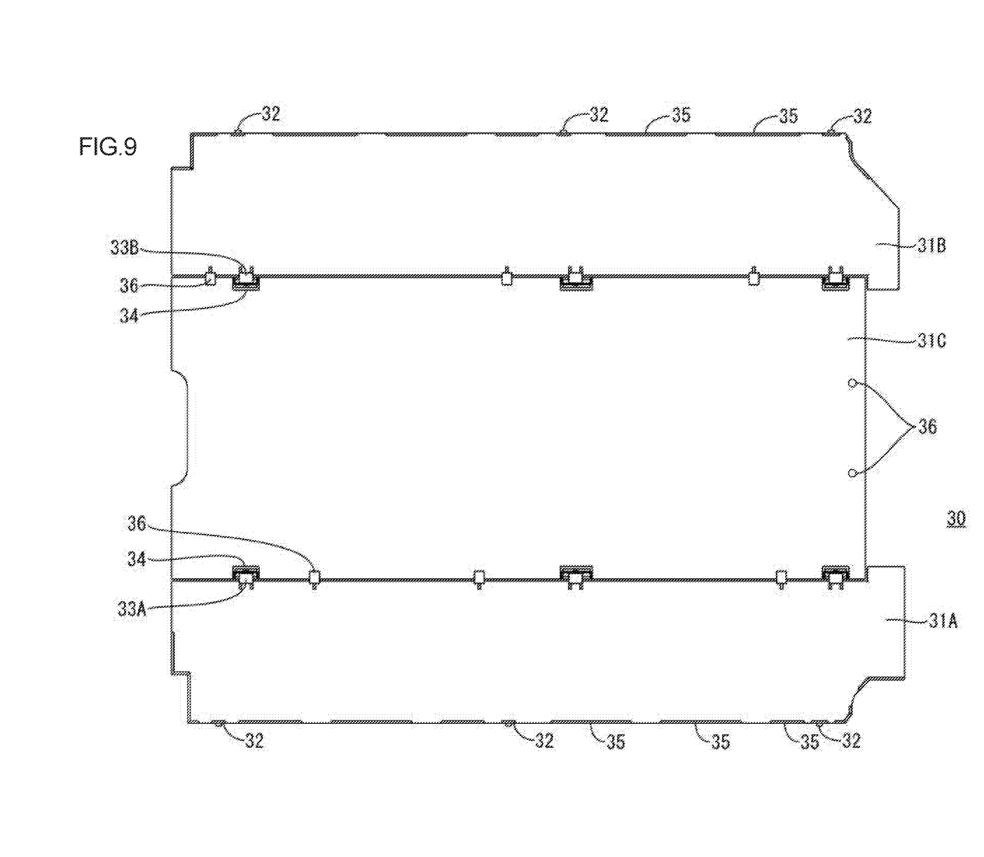

At the same time when, or before or after the connection module 20 is assembled, the cover parts (31A, 31B, and 31C) are coupled by the coupling parts 33 and the central coupling parts 34. Thus, the cover 30 as illustrated in FIG. 9 is prepared. Next, the pair of positioning parts 36 of the central cover part 31C is inserted into the positioning grooves 29 of the connection module 20, so that the cover 30 is positioned. Next, the engaging parts 32 of the first and second cover parts (31A, 31B) are engaged with the engaged parts 27 of the connection module 20; thus, the cover 30 is assembled to the connection module 20. Thus, the power storage module M1 as illustrated in FIG. 1 is completed.

### 6. Effect of the Present Embodiment

According to the present embodiment, the connection module cover 30 includes the first cover part 31A for the first bus bar array 22A, the second cover part 31B for the second bus bar array 22B, and the central cover part 31C. Here, the first cover part 31A is coupled to the second cover part 31B indirectly through the central cover part 31C in a manner that the relative movement is possible.

Specifically, the first cover part 31A and the central cover part 31C are coupled by the first coupling parts 33A of the first cover part 31A and the central coupling parts 34 of the central cover part 31C in a manner that the relative movement is possible. The second cover part 31B and the central cover part 31C are coupled by the second coupling parts 33B of the second cover part 31B and the central coupling parts 34 of the central cover part 31C in a manner that the relative movement is possible. Therefore, the first cover part 31A and the second cover part 31B are coupled through the central cover part 31C in a manner that the relative movement is possible. For example, in a case where the second cover part 31B is unmovable (fixed state), the first cover part 31A is movable relative to the second cover part 31B. On the contrary, in a case where the first cover part 31A is unmovable (fixed state), the second cover part 31B is movable relative to the first cover part 31A.

The first cover part 31A is engaged with one end of the connection module (the first bus bar array 22A) in a manner that the relative movement is possible, and the second cover part 31B is engaged with the other end of the connection module 20 (the second bus bar array 22B) in a manner that the relative movement is possible. Therefore, in a configuration where the first bus bar array 22A and the second bus bar array 22B move in accordance with the tolerance of the electrode pitch of the power storage elements 11, the first cover part 31A and the second cover part 31B can move individually following the movement due to the tolerance of the electrode pitch of the connection module 20. That is to say, by the use of the connection module cover 30 according to the present embodiment having a simple configuration in which the cover 30 is split in accordance with the power storage element stack 10 formed by the two (plurality of) power storage element arrays (12A, 12B) and the individual movement is possible, it is possible to deal with the tolerance of the electrode pitch of the power storage elements 11.

Furthermore, the first cover part 31A and the second cover part 31B are coupled indirectly through the central cover part 31C in a manner that the relative movement is possible. Therefore, in a case where the number of power storage element arrays 12 is increased from two to three, for example, it is only necessary to change the size (change the design) of the central cover part 31C. That is to say, by having the central cover part 31C interposed, the design change of the cover 30 can be reduced with respect to the change in number of power storage element arrays as compared to the case in which the cover 30 is formed by the first and second cover parts (31A and 31B).

In addition, each engaging part 32 of the first and second cover parts (31A and 31B) includes the plate part 32A and the claw part 32B provided to the plate part 32A, and the engaged part 27 of the connection module 20 includes the curved wall 27 that projects from the bus bar holding part 23 and has the engaging part 32 engaged therewith. The curved wall 27 includes the opening 27A into which the engaging part 32 is inserted and whose opening width W4 is larger than the plate width W3 of the plate part 32A of the engaging part. Therefore, the engagement between the first cover part 31A and the second cover part 31B, and the bus bar holding part 23 in a manner that the relative movement is possible can be achieved with a simple configuration. Note that the configuration of the engaging part 32 and the engaged part 27 is not limited to the above configuration.

The first coupling part 33A of the first cover part 31A and the second coupling part 33B of the second cover part 31B include the fitting claw part 33N that is fitted by locking to the central coupling part 34 of the central cover part 31C. The central coupling part 34 includes the opening 34A to which the fitting claw part 33N is fitted and whose opening width W2 is larger than the claw width W1 of the fitting claw part 33N, and the locking part 34B that is formed in the opening 34A to lock the fitting claw part 33N. Therefore, the first cover part 31A and the second cover part 31B, and the central cover part 31C can be coupled with each other with a simple configuration in a manner that the relative movement is possible. Note that the configuration of the first coupling parts 33A, the second coupling parts 33B, and the central coupling parts 34 is not limited to the configuration described above.

### Other Embodiments

The technology described herein is not limited to the embodiment described above and with reference to the drawings. The following embodiments may be included in the technical scope.

(1) The connection module cover 30 may be formed by the first cover part 31A and the second cover part 31B without the central cover part 31C. In other words, the first coupling parts 33A of the first cover part 31A may be directly coupled to the second cover part 31B in a manner that the relative movement is possible, and the second coupling parts 33B of the second cover part 31B may be directly coupled to the first cover part 31A in a manner that the relative movement is possible. In this case, when the configuration of the second coupling parts 33B is the same as that of the central coupling parts 34, for example, the first cover part 31A and the second cover part 31B can be coupled in a manner that the relative movement is possible.

That is to say, it is only necessary that the first coupling parts 33A of the first cover part 31A are directly or indirectly coupled to the second cover parts 31B in a manner that the relative movement is possible. In addition, it is only necessary that the second coupling parts 33B of the second cover part 31B are directly or indirectly coupled to the first cover part 31A in a manner that the relative movement is possible.

1. A connection module cover that is to be attached to a connection module to be assembled to a power storage element stack, the power storage element stack including a plurality of power storage element arrays in each of which a plurality of power storage elements including electrode terminals of a positive electrode and a negative electrode are arranged,
wherein:
the power storage element array in a first array includes a first electrode terminal array that is positioned at one end of the power storage element stack in a direction perpendicular to a direction where the power storage elements are arranged in the power storage element array;
the power storage element array in a final array includes a second electrode terminal array that is positioned at another end of the power storage element stack in the direction perpendicular to the direction where the power storage elements are arranged;
the connection module includes a plurality of bus bars that electrically connect between the electrode terminals of the power storage element arrays; and
the plurality of bus bars include:
a first bus bar array for the first electrode terminal array; and
a second bus bar array for the second electrode terminal array;
the connection module cover comprising:
a first cover part that covers the first bus bar array; and
a second cover part that covers the second bus bar array,
wherein:
the first cover part includes:
an engaging part that is engaged with one end of the connection module in the direction perpendicular to the direction where the power storage elements are arranged in a relatively movable manner; and
a first coupling part that is directly or indirectly coupled to the second cover part in a relatively movable manner; and
the second cover part includes:
an engaging part that is engaged with another end of the connection module in the direction perpendicular to the direction where the power storage elements are arranged in a relatively movable manner; and
a second coupling part that is directly or indirectly coupled to the first coupling part of the first cover part in a relatively movable manner.

2. The connection module cover according to claim 1, further comprising a central cover part that is disposed between the first cover part and the second cover part,
wherein the central cover part includes central coupling parts that are coupled to the first coupling part and the second coupling part and that are coupled to the first cover part and the second cover part in a relatively movable manner.

3. The connection module cover according to claim 2, wherein:
each of the first coupling part and the second coupling part includes a fitting claw part that is fitted by locking to each of the central coupling parts; and
each of the central coupling parts includes:
an opening to which the fitting claw part is fitted and whose opening width is larger than a claw width of the fitting claw part; and
a locking part that is formed in the opening to lock the fitting claw part.

4. The connection module cover according to claim 3, wherein:
the central coupling parts are provided at a plurality of positions of the central cover part along the direction where the power storage elements are arranged; and
the openings of the central coupling parts have different opening widths.

5. The connection module cover according to claim 2, wherein the central cover part includes a positioning part configured to position the direction where the power storage elements are arranged with respect to the connection module.

6. The connection module cover according to claim 1, wherein the connection module cover has a shape of covering an entire upper part of the connection module.

7. A connection module comprising:
the connection module cover according to claim 1; and
a plurality of bus bar holding parts each provided in accordance with each of the plurality of bus bars and holding each bus bar in an insulated state,
wherein the bus bar holding parts for the engaging parts of the first cover part and the second cover part include engaged parts with which the engaging parts are engaged in a relatively movable manner.

8. The connection module according to claim 7, wherein:
the engaging part includes a plate part and a claw part provided to the plate part;
the engaged part includes a curved wall which projects from the bus bar holding part and with which the engaging part is engaged; and
the curved wall includes an opening in which the engaging part is inserted and whose opening width is larger than a plate width of the plate part of the engaging part.

9. The connection module according to claim 8, wherein:
the engaging parts are provided at a plurality of positions of the first cover part and the second cover part along the direction where the power storage elements are arranged; and
the openings of the engaged parts have different opening widths.

10. The connection module according to claim 6, further comprising a slit provided between the bus bar holding parts to deal with a stacking tolerance of the power storage element stack,
wherein each of the first cover part and the second cover part includes a sidewall that covers the slit.
